(19) United States
(12) Patent Application Publication
(10) Pub. No.: US 2017/0147029 A1
(43) Pub. Date: May 25, 2017

(54) Vandal Proof Knob

(71) Applicant: Ercito Anthony Mazzella, Bayshore, NY (US)

(72) Inventor: Ercito Anthony Mazzella, Bayshore, NY (US)

(21) Appl. No.: 14/951,226

(22) Filed: Nov. 24, 2015

(51) Int. Cl. G05G 1/08; G07F 17/20; G07F 7/00; G05G 1/12

(52) U.S. Cl. CPC G05G 1/082; G05G 1/12; G07F 17/20; G07F 7/005

(57) ABSTRACT

The vandal proof knob is designed to protect self-serve car wash station control boxes from costly damage from acts of vandalism or robbery by using a single piece construction of a knob with an elongated shaft that mates with the adjustment shaft of a standard rotary switch. The elongated shaft combined with a separate durable metal bracket mounted inside the control box allows for the rotary switch to be recessed approximately three inches inside the control box offering additional protection against vandalism. The bracket is secured to the control box using at least two fasteners and the rotary switch is also attached to the distal end of the bracket using at least two fasteners. Finally the front face of the knob has position indicating markings made as part of the single piece construction which also provides additional protection against vandalism.

### FIELD OF THE INVENTION

The present invention relates to the field of self-serve car wash control box knobs, and more particularly to a control box knob and supporting bracket design that has several unique capabilities over control box knobs of prior art.

### BACKGROUND OF THE INVENTION

The first semi-automatic car wash in the United States was built in 1946 in Detroit, Michigan and used automatic pulley systems with manual brushing. Since then they have grown in popularity and in 2013 there were approximately 113,000 car washes in the United States. The self-serve car wash is one of the more popular designs currently in use, and most frequently uses simple coin operated control boxes with an internal rotary switch that activates the car wash once the proper amount of coins have been inserted by the customer. Unfortunately, these self-serve car wash stations are the target of vandalism by either frustrated customers who may have been upset over a malfunctioning car wash control box or from thieves trying to break open the control boxes to steal the coins. Most often, the switch and knob have to be replaced and re-wired after an act of vandalism which is a costly situation for the owner of the car wash station.

A review of the self-serve car wash control boxes of prior art show a large variety of knob and control box designs, but none of these designs offer any protection again vandalism attacks such as striking the control box knob and rotary switch with a hammer or similar tool. Indeed, there exists the need for a vandal proof knob that will provide the owners of self-serve car washes a much higher degree of protection of their car wash control boxes from attempted acts of vandalism or robbery.

### BRIEF SUMMARY OF THE INVENTION

It is a first object of the present invention to provide a means to recess the rotary switch deeper inside the control box.

It is yet another object of the present invention to provide a knob that is made out of a single piece of a strong material such as stainless steel with an elongated shaft to fit through the front wall of the control box.

It is yet another object of the present invention to provide a supportive bracket for the rotary switch shaft that prevents energy from impact strikes against the control box wall from directly damaging the rotary switch.

It is a final object of the present invention to provide a knob that has a cylindrical shaped front face with embedded alignment arrow markings such that the alignment arrows cannot be easily removed from vandalism attacks.

### BRIEF DESCRIPTION OF THE INVENTION

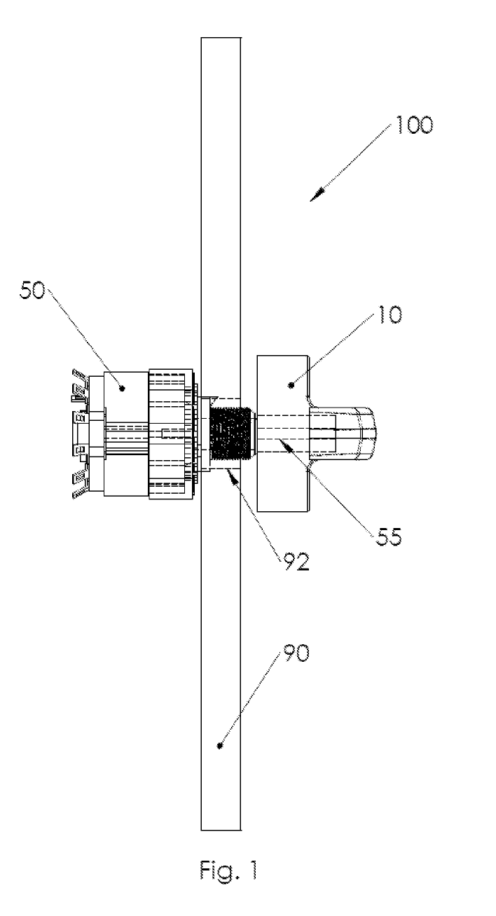

FIG. 1 is a side view of the control box front panel, knob and rotary switch of prior art car wash self-serve stations.

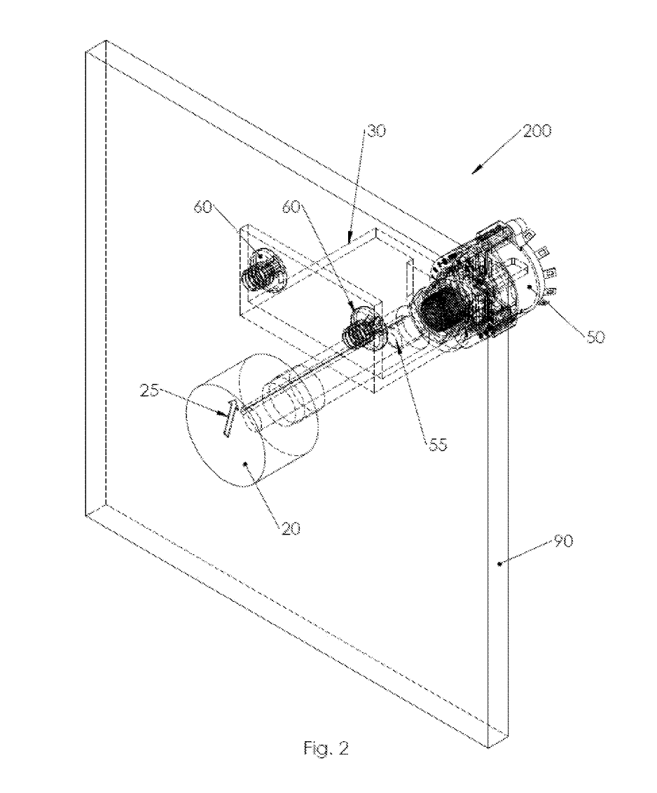

FIG. 2 is a perspective front view of the control box knob, support bracket and rotary switch of the present invention.

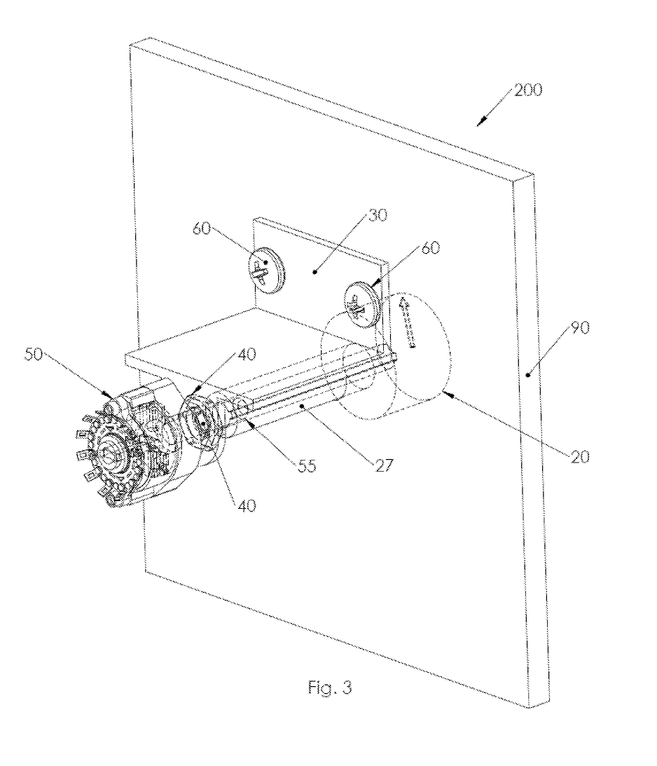

FIG. 3 is a perspective back side view of the control box knob, support bracket and rotary switch of the present invention.

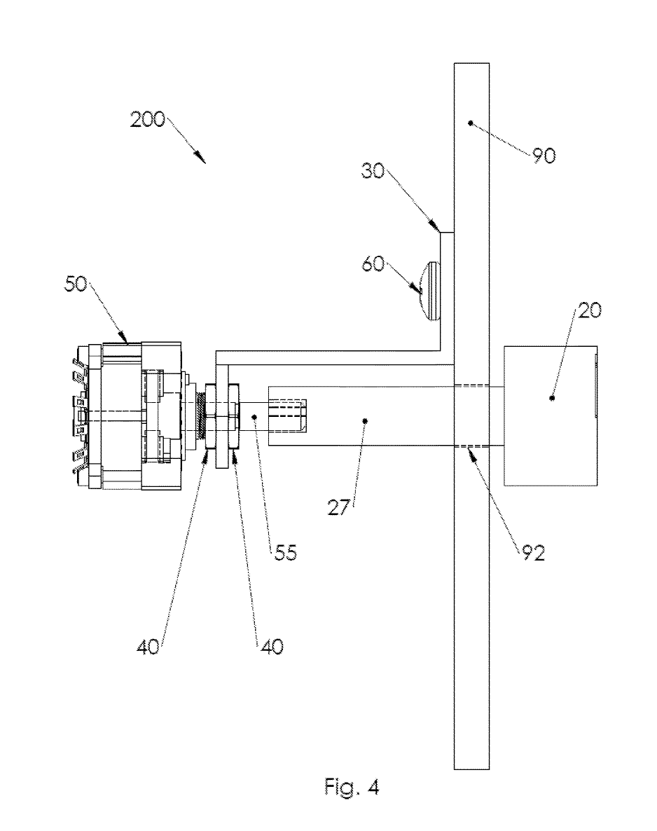

FIG. 4 is a side view of the control box knob, support bracket and rotary switch of the present invention.

### DETAILED DESCRIPTION OF THE INVENTION

Referring now to the drawings and in particular FIG. 1, a typical prior art self-serve control box 100 is shown in a side view. The front panel of the prior art control box 90 typically has a center aperture 92 through which is mounted flush with the control box a rotary switch 50. Said rotary switch 50 terminates in a rotary switch adjustment shaft 55 which concentrically mates with a switch knob 10. In prior art , typically the switch knob 10 is made either of plastic or a lightweight metal such as aluminum. These designs as previously mentioned can be easily damaged or broken apart by vandals using simple and easily available tools such as hammers, mallets or even baseball bats. Typically not only is the switch knob 10 destroyed, but also the more expensive internal rotary switch 50 which controls the self-serve car wash.

Referring next to FIGS. 2 through 4, the vandal proof knob 200 of the present invention shall next be discussed in order to provide a detailed description of its novel features over prior art control box switch knobs. In the vandal proof knob 200 of the present invention, a vandal proof switch knob 20 is made of a tough material such as stainless steel and also has preferably a front head thickness of between 0.5 inch and 2 inches. Said vandal proof switch knob 20 also has a recessed arrow marking 25 that can either be typically produced by conventional manufacturing methods such as machining, engraving, or stamping. Said vandal proof switch knob 20 also has an elongated shaft 27 that has an aperture at the distal end of the shaft that is used to rigidly attach to said rotary switch adjustment shaft 55. Although these figures do not show any particular attachment method, one skilled in the art of shaft mating design can use conventional methods such as keyed shafts, fasteners such as set screws or pins, or metal to metal bonding adhesives.

Referring again to FIGS. 2 through 4, the single piece construction of said rotary vandal proof switch knob 20 combined with the tight tolerance fit between shaft 27 and control box panel aperture 92 provides a very high degree of protection to said vandal proof switch knob 20 against typical acts of vandalism as previously described. As a second means of protecting said rotary switch 50, a securing bracket 30 is used to recess said rotary switch 50 by preferably between 2.5 to 3.5 inches behind said control box front panel 90. In the preferred embodiment, said bracket 30 is securely fastened to the interior wall of said front panel 90 by conventional means such as using screw fasteners 60. Referring now specifically to FIG. 4, in the preferred embodiment, said rotary switch 50 is securely fastened to the distal end of said bracket 30 by mechanical fasteners such as using two threaded nuts 40. As an additional advantage beyond the recessing of said rotary switch 50 by using said bracket 30, the body of said bracket 30 will absorb most of the impact energy from vandalism attacks to the front panel 90 of the self-serve control box, and therefore the present invention 200 provides a very high degree of protection to said rotary switch 50 against typical acts of vandalism as previously described.

What is claimed is:

1. A control box for use in self-serve car wash stations which consists of:
a. A knob with a front cylindrical body section, a rear elongated shaft with an aperture at the distal end with a depth of at least ¼ inch; and
b. A bracket having a front face parallel to the control box front panel, an elongated section that is parallel to the axis of the knob and a rear face parallel to the front end and having a single aperture; and
c. A rotary switch that is secured to the bracket using at least two fasteners such as threaded nuts.

2. The knob according to claim 1 that has at least one position indication arrow marking on the front cylindrical body section and a thickness of between 0.5 and 2 inches.

3. The knob according to claim 1 that has at least one threaded hole that is cut radially thru the distal end aperture for use in further securing the knob to the rotary switch.

4. The knob according to claim 1 that has an aperture at the distal end of the elongated shaft with a depth between 0.25 and 1.5 inches.

5. The bracket according to claim 1 that has at least two apertures through the front end and a wall thickness of between 1/16 inch and ⅜ inch.

6. The bracket according to claim 1 that has a rear face single aperture diameter between 1/16 inch and 0.5 inch and geometrically centered on the rear face.
